(19) United States
(12) Patent Application Publication
(10) Pub. No.: US 2003/0088450 A1
(43) Pub. Date: May 8, 2003

(54) Material requirements planning method for the calculation of supplier provision of materials

(76) Inventors: Hung-Liang Chiu, Taipei (TW); Hua-Shan Hsu, Taipei (TW); Jih-Hong Huang, Taipei (TW)

Correspondence Address: BIRCH STEWART KOLASCH & BIRCH, PO BOX 747, FALLS CHURCH, VA, 22040-0747, US

(21) Appl. No.: 09/985,562

(22) Filed: Nov. 5, 2001

(51) Int. Cl. G06F 17/60

(52) U.S. Cl. 705/8

(57) ABSTRACT

A material requirements planning method of calculating supplier material supply aims at resolving the problems of lot-size material issuing methods on production schedule systems in the manufacturing industry. A material requirements planning server of an enterprise end server simulates material issuing operations during a stock-out period, and executes timely delivery of particular parts or components, utilizing as-needed delivery rather than lot-size delivery. The disclosed method includes at least the steps of: capturing data through an Enterprise Resource Planning (ERP) server, receiving and storing a promise order from the supplier end on the material requirements planning server, simulating with the material requirements planning server to determine whether the promise order can meet material requirements on the shortage list, releasing an original build order from stock-outs, generating data of the build order to the Enterprise Resource Planning (ERP) server and implementing an available to promise (ATP) to directly deliver materials through the Enterprise Resource Planning (ERP) server.

### BACKGROUND OF THE INVENTION

1. Field of the Invention

This invention relates to a method for the calculation of a supplier's provision of materials, and particularly a material requirements planning method that is capable of calculating the supply of materials from suppliers, as well as issuing materials as needed, instead of according to lot-size , in material issuing operations..

2. Related Art

A solution to inventory control problems for enterprises is supply chain software, on which services and supportive management of the flow of material provided to enterprises relate to Logistics Support Management (LSM), including management of systems of material supply, manufacturing planning and control, transportation, and distribution. Logistics Support Management (LSM) manages the operations of channel and distribution, inventory control, and manufacturing through planning and control of processes of materials to achieve the required level of services by fully utilizing system resources. Statistics from the Council of Logistics Management show that nearly twenty to thirty percent of sales revenue in various industries relates to logistics costs. Therefore, logistics management of the whole system of production and distribution, whether good or bad, has a great impact on costs and quality of services.

With development of information technology and constant expansion of business scales, product items are becoming more and more complicated, and restricted management of the flow of material no longer meets the requirements of modem enterprises. Therefore, a system of Supply Chain Management (SCM) under integral considerations is born. The most important factor effecting all operation costs in the Supply Chain, as well as a chief concern to manufacturing enterprises, is the production process of the flow of material, including the processes of material procurement, storage, delivery and distribution, and manufacturing.

Supply Chain Management (SCM) aims at professional knowledge of the flow of material, further generates Supply Chain Execution (SCE) to integrate upstream and downstream operations in a supply chain from the standpoint of Supply Chain Management (SCM), and focuses on knowledge of the “execution” side from operations of the flow of material under the Warehouse Management System (WMS). With recent and rapid development of relevant e-commerce technology, the Supply Chain Management (SCM) has further developed more detailed and professional knowledge, i.e., E-Fulfillment Processes on c-commerce orders.

E-Fulfillment Processes on e-commerce orders differ from general software packages of Material Resource Planning (MRP) as they are capable of not only resolving issues on managing materials and inventory control for respective companies, but also sorting out problems of materials and enhancing efficiency while extending total Supply Chain Management (SCM) to the supplier ends. Capable to Promise (CTP) productions from one single site to multiple-sites, as well as the trends of the flow of material and channel and distribution, are problems that multi-national manufacturing companies have to face . The current development of B2B e-commerce is mainly focused on how to merchandise on the Internet. However, daily problems in the manufacturing industry are: what parts or components need to be purchased, how to plan production schedules after purchasing materials, how to arrange delivery of finished goods , how to manage excess/surplus stock, etc. For example, capacity forecast and Formal orders are not the same thing, and even a formal order could possibly change without notice. Therefore, loss due to excess/surplus stock resulting from mistaken list making and incorrect material preparation is often caused. Present Material issuing methods on an Enterprise Resource Planning (ERP) system mostly employ a lot-size material issuing method. If a forecast order is far lower than an actual order in quantity, the Enterprise Resource Planning (ERP) system is unable to issue materials for production to satisfy production-planning requirements. Inversely, such as a manual or a handbook, there will be problems with manufacturing as materials are lacking during the production process.

Hence, the application of a material requirements planning method to the Supply Chain Management (SCM) in the manufacturing industry, which applies to forecast orders on e-commence orders and material providing status from the supplier ends, has become a heavily focused subject.

### SUMMARY OF THE INVENTION

view of the foregoing, the invention aims at resolving the preceding disadvantages by providing a material requirements planning method for calculating material supply status from suppliers. The primary object of the invention is to attack the common problem that now exists in the supply chain of the general manufacturing industry in which different vendors provide different parts or components, and constant shortage of materials on the production lines may be particular items. The invention offers a method through a material requirements planning server to simulate planned production schedules in which parts or components are lacking, then through a B to B platform to notify the supplier ends for timely replenishing of those particular parts or components. Therefore, the production lines can still go on with production processes by putting utilizable materials on hand from build orders to enhance efficiency and achieve the goal of issuing particular parts or components for production by eliminating the disadvantages of previously used lot-size material issuing.

The material requirements planning method according to the invention at least consists of: capturing data through an Enterprise Resource Planning (ERP) server, receiving a promise order from the supplier end and storing it on the material requirements planning server, simulating with the material requirement planning server to see if the promise order will satisfy required parts or components on the shortage list, releasing an original stock-out build order, generating data of the build order to the Enterprise Resource Planning (ERP) server, and executing an available to promise (ATP) through the Enterprise Resource Planning (ERP) server to directly issue materials.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic representation of the material requirements planning method for calculation of supplier provision of materials of the invention.

FIG. 2 is a flowchart representation of presently known operation of issuing materials.

FIG. 3 is a flowchart representation of timely delivering material operation according to the invention.

### DETAILED DESCRIPTION OF THE INVENTION

The invention aims at providing a material requirements planning method for calculating supplier material supply and targeting Supply Chain Management (SCM) and Enterprise Resource Planning (ERP), which are presently widely advocated in the market place. The goal of the invention is to improve the material issuing method on a lot-size basis by changing it to an as needed basis. The enterprise server can communicate with suppliers through a B to B platform to ask for material replenishment without stopping the operations of the production lines due to shortage of particular parts or components.

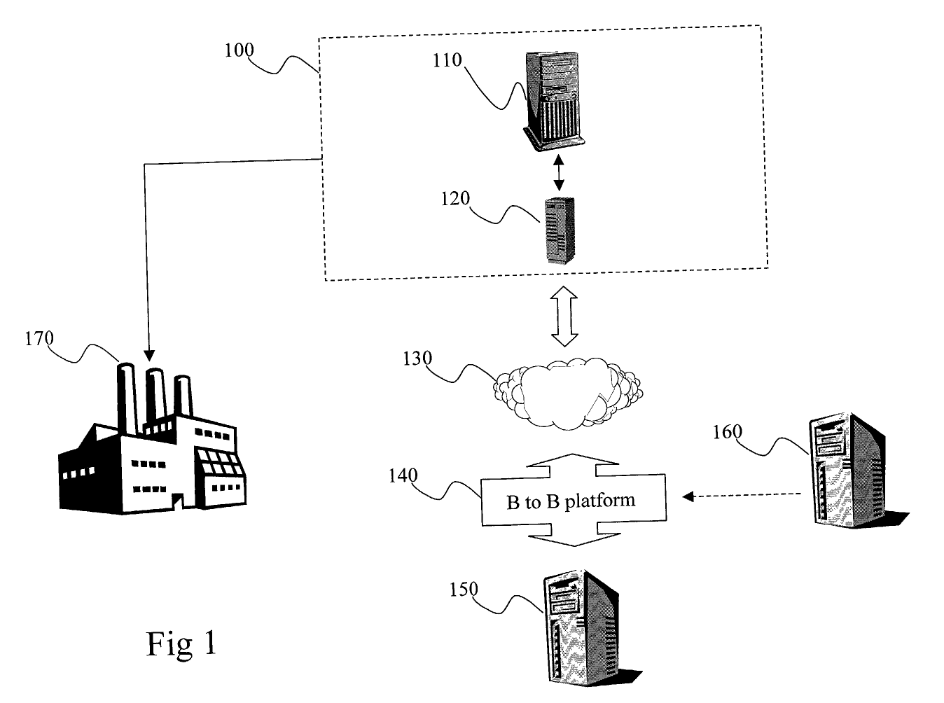

The feasibility and practicality of the invention will be elaborated by means of an embodiment depicted in the following. This disclosed method can integrate data from different suppliers, so the suppliers can match the production of the supply chain managers in a timely fashion, and it achieves the objects of increasing productivity and lowering inventory. FIG. 1 is a schematic representation of the material requirements planning method for calculation of material supply of the invention. Details are provided below.

An enterprise end server 100 comprises two servers, one is an Enterprise Resource Planning (ERP) server 110 to calculate capability and material planning as references for decision makers, and the other is a material requirements planning server 120 to determine required capability, which is based on product orders from the client ends 160, so as to place material purchase orders to the suppliers 150. The enterprise end server 100 transfers data through the Internet 130 and communicates with the supplier ends 150 and the client ends 160 through a B to B platform. Once the enterprise end server 100 confirms a product order from one client end 160 as well as a material purchase order to the supplier ends 150, the enterprise end server 100 notifies the production lines 170 to proceed with production. The above-mentioned material requirements planning server 120 is linked to the Enterprise Resource Planning (ERP) server 110 through an enterprise internal network, which can be an Ethernet.

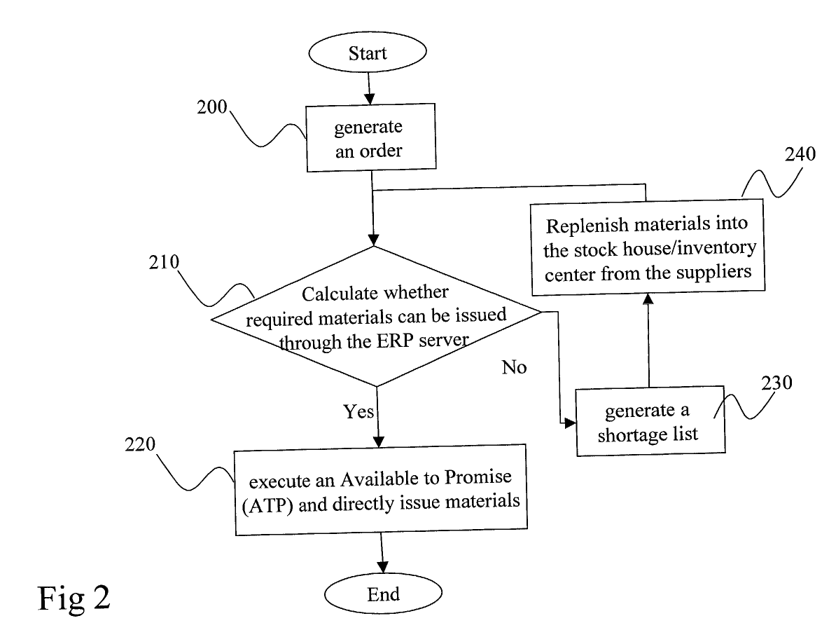

With reference to FIG. 2, the presently known procedure of issuing materials is described as follows:

First, the enterprise end server 100 will generate an order (step 200), which relates to a transferred actual order from the client end 160, and presents the requirement of the client end 160. Then through the Enterprise Resource Planning (ERP) server 110 calculate if required materials are able to be issued (step 210). The required materials are compared with existing inventory stock, and the supplier ends 150 are notified of the quantity of shortage for replenishing materials. If the total quantity of materials delivered by the supplier ends 150 and existing inventory stock can meet material requirements , the Enterprise Resource Planning (ERP) server 110 executes an available to promise (ATP) to directly issue materials (step 220). Otherwise, it generates a shortage list (step 230) and transfers the list to the supplier ends 150. The shortage list points out materials required by the suppliers 150, and the production lines await material replenishment from the supplier 150 to the inventory center (step 240) before going back to step 210. If required materials can not be sufficiently replenished, the production lines 170 are not capable of operating, so steps 210, 230 and 240 are constantly repeated. This is the operation of lot-size material issuing method in the past.

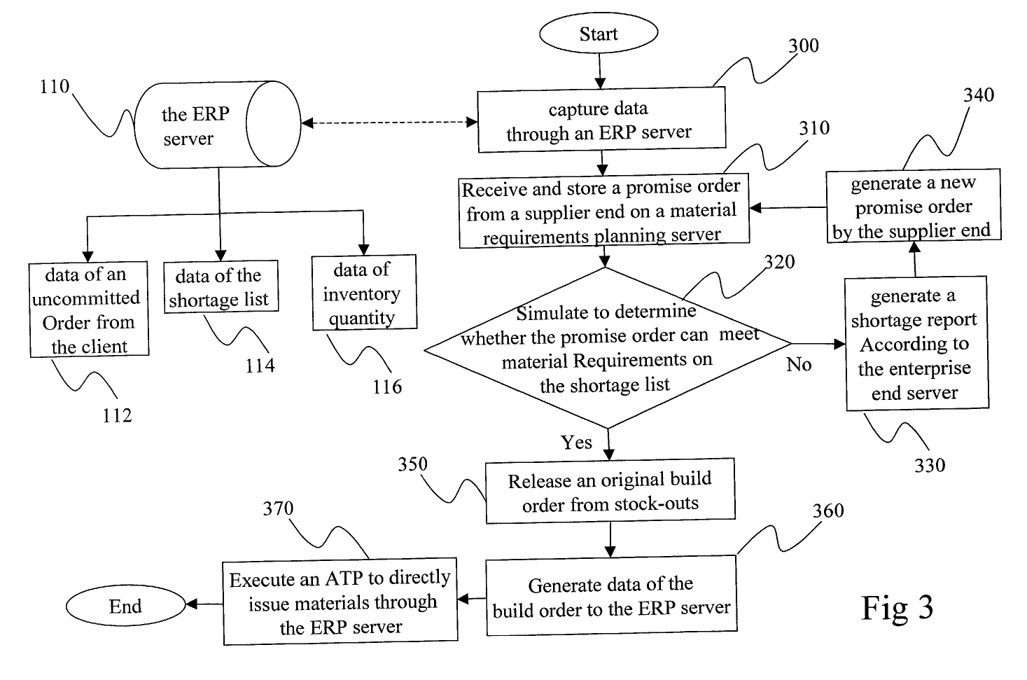

With reference to FIG. 3, the delivery of materials operation of the material requirements planning method for calculation of supplier provision of materials of the invention, explains production operation of utilizing material issuing on an as needed basis.

First, the Enterprise Resource Planning (ERP) server 110 captures data (step 300) that consists of (1) data of an uncommitted order, which has been received from a client end 160 through the enterprise end server 100, but not yet been processed into a build order through the material requirements planning server 120, (2) data of a shortage list, which has been processed into a build order by the material requirements planning server 120, but is still short of some parts or components, and (3) data of inventory, which is the existing inventory stock status being searched by the material requirement planning server 120. The Enterprise Resource Planning (ERP) server 110 then receives a promise order from a supplier end and stores the promise order on the material requirements planning server 120 (step 310), which relates to a material supply list that is based on shortage of required materials to deliver materials from the supplier end 150 to the enterprise end server 100. The material requirements planning server 120 performs a simulation to determine whether the promise order can meet material requirements of the shortage list (step 320). The simulation relates to a simulated action by the material requirements planning server 120 to examine material supply status on the production schedule . After the simulation, if the promise order can satisfy required parts or components on the shortage list, data of the original build order is released (step 350), and data of the build order is stored on the Enterprise Resource Planning (ERP) server 110 (step 360). Since the Enterprise Resource Planning (ERP) server 110 utilizes the material issuing method on an as needed basis, even if required materials are still not delivered to the production lines, the Enterprise Resource Planning (ERP) server can execute an available to promise (ATP) to directly issue materials (step 370). However, if the promise order cannot satisfy required parts or components on the shortage list, the enterprise end server 100 generates a shortage report (step 330) on which the material quantity is the total amount of required materials minus the sum of the promise order and existing inventory quantity. The supplier end 150, therefore, generates a new promise order (step 340), which is generated according to the shortage report of the enterprise end server 100, and replenishes required materials before returning to step 320 to continue the process. The difference between the disclosed method herein and presently known technology is that once the supplier end 150 generates a promise order , the enterprise end server can continue with its production schedule according to that promise order , without wasting time waiting for material replenishment from the supplier end 150 to the production lines. Hence, even if the supplier end 150 can not replenish sufficient materials at one time, the enterprise end server can still process based on materials on hand.

However, the material requirements planning server 120 simulating operation of material issuing for shortage mainly focuses on required materials of the subsequent operations on the production schedule system in the manufacturing industry. Both the supplier end 150 and the clients 160 communicate with the enterprise end server 100 for transactions and information transfer through a B to B platform.

The invention in the form of the material requirements planning method for calculation of supplier material supply has been described herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. A material requirements planning method for calculation supplier provision of materials relates to a method that employs to proceed simulated operation of material issuing for shortage through a material requirements planning server of an enterprise end server on the production schedule system in the manufacturing industry. The enterprise end server links to the Internet for transferring updated information to a supplier end to complete timely material delivery. The disclosed method at least includes the following steps:
Capturing some data through the Enterprise Resource Planning (ERP) server;
Receiving an order promising from the supplier end and storing the order promising to the material requirements planning server;
Simulating by the material requirements planning server to see if the order promising can satisfy required materials on the shortage list;
Releasing an original build order for shortage;
Generating data of the build order to the Enterprise Resource Planning (ERP) server; and
Executing an available to promise (ATP) through the Enterprise Resource Planning (ERP) server and directly issuing materials.

2. The disclosed material requirements planning method for calculation supplier provision of materials of claim 1, wherein the material requirements planning server and the Enterprise Resource Planning (ERP) server are linked through an enterprise internal network, which can be an Ethernet.

3. The disclosed material requirements planning method for calculation supplier provision of materials of claim 1, wherein the data respectively indicates data of an uncommitted order, data of a shortage list, and data of an inventory quantity.

4. The disclosed material requirements planning method for calculation supplier provision of materials of claim 3, wherein the data of an uncommitted order is an order received from a client by the enterprise end server, but not yet being processed into a build order through the material requirements planning server.

5. The disclosed material requirements planning method for calculation supplier provision of materials of claim 3, wherein the data of the shortage list has been processed to be a build order through the material requirement planning server, but still remains shortage of particular parts or components.

6. The disclosed material requirements planning method for calculation supplier provision of materials of claim 3, wherein the data of an inventory quantity relates to existent inventory stock on the inventory center being researched through the material requirements planning server.

7. The disclosed material requirements planning method for calculation supplier provision of materials of claim 1, wherein the order promising relates to the material supply list by the supplier end, generated according to the shortage list, aims at timely providing shortage materials to the enterprise end server.

8. The disclosed material requirements planning method for calculation supplier provision of materials of claim 1, wherein the steps of simulating by the material requirements planning server to see if the order promising can satisfy required materials on the shortage list relate to the following steps while it is under unsatisfied condition,
Generating a shortage report according to the enterprise end server;
generating a new order promising by the supplier end; and
transferring the new order promising to the material requirements planning server.

9. The disclosed material requirements planning method for calculation supplier provision of materials of claim 8, wherein the material quantity from the shortage report is the total amount of required materials minus the sum of the order promising and a inventory quantity.

10. The disclosed material requirements planning method for calculation supplier provision of materials of claim 8, wherein the new order promising is generated according to the shortage report to replenish required materials of the shortage report.

11. The disclosed material requirements planning method for calculation supplier provision of materials of claim 8, wherein the new order promising being transferred back to the material requirements planning server is for proceeding the material issuing simulation through the material requirements planning server.

12. The disclosed material requirements planning method for calculation supplier provision of materials of claim 1, wherein the operation of simulating material issuing for stock-outs is targeting required materials of the subsequent operation on the production schedules in the manufacturing industry.

13. The disclosed material requirements planning method for calculation supplier provision of materials of claim 1, wherein the Internet connection is through a B to B platform to process commercial transactions and information transfer.
